(19) United States
(12) Patent Application Publication
(10) Pub. No.: US 2012/0288295 A1
(43) Pub. Date: Nov. 15, 2012

(54) IMAGE FORMING SYSTEM

(75) Inventor: Kenichiro Kitajima, Toride-shi (JP)

(73) Assignee: CANON KABUSHIKI KAISHA, Tokyo (JP)

(21) Appl. No.: 13/455,387

(22) Filed: Apr. 25, 2012

(30) Foreign Application Priority Data
May 11, 2011 (JP) 2011-105840

(51) Int. Cl. G03G 15/20

(52) U.S. Cl. 399/69

(57) ABSTRACT

An image forming system including: an executing unit configured to execute a duplex image forming mode including: a first duplex image forming mode in which a recording material, which is conveyed from a first recording material containing portion and has one surface subjected to image formation by a first image forming apparatus, is conveyed by a conveying unit, and another surface of the recording material is subjected to image formation by a second image forming apparatus; and a second duplex image forming mode in which one surface and another surface of a recording material conveyed from a second recording material containing portion are sequentially subjected to image formation by the second image forming apparatus; and an input portion through which an operator inputs a setting for execution of the second duplex image forming mode. Thus, power consumption can be reduced.

### BACKGROUND OF THE INVENTION

1. Field of the Invention

The present invention relates to an image forming system which further subjects a recording material having an image formed thereon using a first image forming apparatus to image formation using a second image forming apparatus.

2. Description of the Related Art

There is widely used an image forming apparatus in which a toner image forming portion forms a toner image and transfers the toner image onto a recording material, and then a fixing device heats and pressurizes the recording material to fix the image. Further, there is widely used an image forming apparatus which performs duplex printing, in which a recording material having a first surface with an image fixed thereon is fed to the toner image forming portion again in a state in which a front surface and a back surface of the recording material are reversed, thereby similarly transferring a toner image onto a second surface thereof.

Japanese Patent Application Laid-Open No. 2006-58881 (U.S. Pat. No. 7,024,152) describes a multiply-connecting image forming system in which two independent image forming apparatus of the same type, which individually perform duplex printing, are connected to each other in series through a relay unit including a switchback mechanism for the recording material. In this case, the relay unit reverses the front surface and the back surface of the recording material, thereby executing duplex printing in which a first image forming apparatus on an upstream side and a second image forming apparatus on a downstream side perform printing on one side in a divided manner.

However, in a conventional case, when duplex image formation is performed and when the two image forming apparatus can both continue the image formation, the duplex image formation is performed by the two image forming apparatus. Therefore, even when reduction in power consumption is desired, the image formation is performed always by the two image forming apparatus. As a result, the demand of reducing the power consumption cannot be satisfied.

### SUMMARY OF THE INVENTION

According to an exemplary embodiment of the present invention, there is provided an image forming system including: an executing unit configured to execute a duplex image forming mode including: a first duplex image forming mode in which a recording material, which is conveyed from a first recording material containing portion and has one surface subjected to image formation by a first image forming apparatus, is conveyed by a conveying unit, and another surface of the recording material is subjected to image formation by a second image forming apparatus; and a second duplex image forming mode in which one surface and another surface of a recording material conveyed from a second recording material containing portion are sequentially subjected to image formation by the second image forming apparatus; and an input portion through which an operator inputs a setting for execution of the second duplex image forming mode. Thus, the present invention can reduce power consumption.

Further features of the present invention will become apparent from the following description of exemplary embodiments with reference to the attached drawings.

### BRIEF DESCRIPTION OF THE DRAWINGS

FIG. 1 is an explanatory diagram illustrating a configuration of a multiply-connecting image forming system.

FIG. 2 is an explanatory diagram illustrating another example of a relay unit illustrated in FIG. 1.

FIG. 3 is a block diagram illustrating a control system of the multiply-connecting image forming system.

FIG. 4 is a block diagram illustrating a communication system of the multiply-connecting image forming system.

FIG. 5 is an explanatory diagram illustrating access to a connecting system controlling portion from an external computer.

FIG. 6 is an explanatory diagram illustrating a configuration of an operating portion.

FIG. 7 is an explanatory diagram illustrating an information setting screen.

FIG. 8 is an explanatory diagram illustrating a timer setting screen.

FIG. 9 is an explanatory diagram illustrating a sleep time setting screen.

FIG. 10 is an explanatory diagram illustrating a power saving mode transition time setting screen.

FIG. 11 is an explanatory diagram illustrating a silent mode transition time setting screen.

FIG. 12 is an explanatory diagram illustrating a menu screen.

FIG. 13 is an explanatory diagram illustrating a system administration setting screen.

FIG. 14 is an explanatory diagram illustrating a timer setting screen.

FIG. 15 is an explanatory diagram illustrating a network communication setting screen.

FIG. 16 is an explanatory diagram illustrating a multiply-connecting system setting screen.

FIG. 17 is a flowchart illustrating duplex printing control according to a second embodiment of the present invention.

FIG. 18 is a flowchart illustrating duplex printing control according to a third embodiment of the present invention.

### DESCRIPTION OF THE EMBODIMENTS

Hereinafter, an embodiment mode of the present invention will be described in detail with reference to the drawings.

A toner image forming portion is enabled regardless of full color/monochrome, one-component developer/two-component developer, direct transfer method/recording material conveyance method/intermediate transfer method, charging methods, exposure methods, kinds of a photosensitive member, and the like. An image forming apparatus may be used for various purposes, such as a printer, various printing machines, a copying machine, a fax machine, and a multifunction peripheral, through addition of necessary devices, equipment, and housing configurations.

(Multiply-connecting Image Forming System)

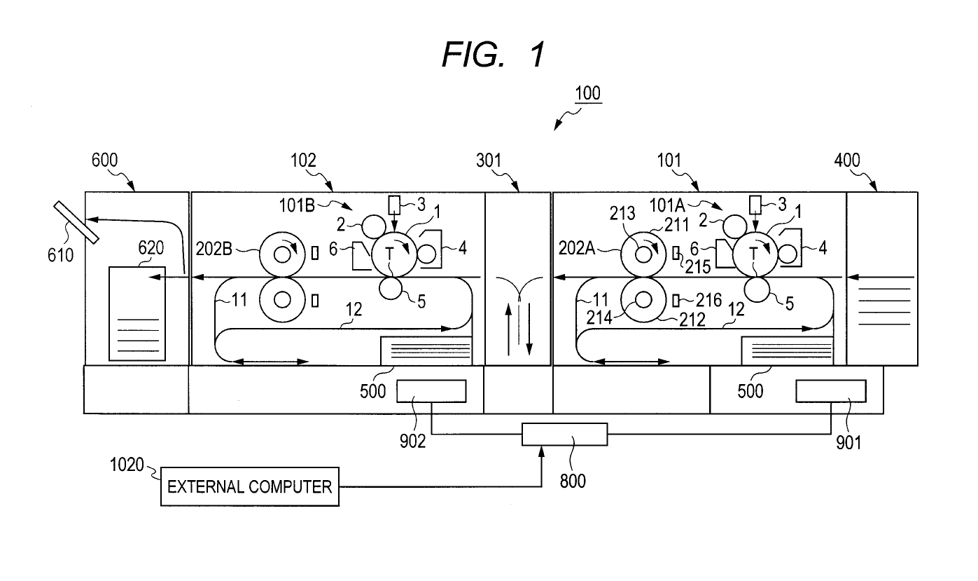

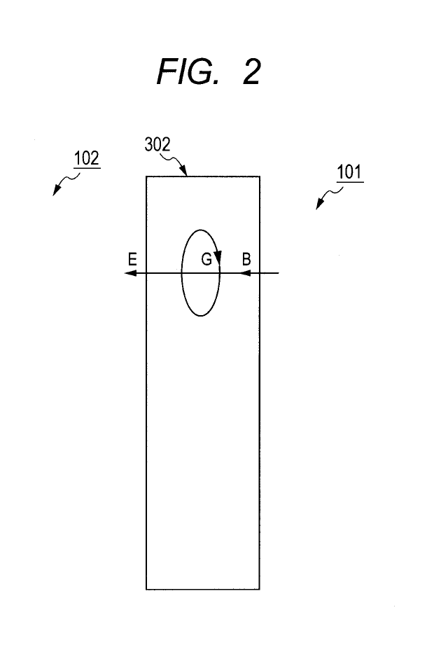

FIG. 1 is an explanatory diagram illustrating a configuration of a multiply-connecting image forming system. FIG. 2 is an explanatory diagram illustrating another example of a relay unit.

As illustrated in FIG. 1, in a multiply-connecting image forming system 100, a first image forming apparatus 101 and a second image forming apparatus 102 are connected to each other in series through a relay unit (conveying unit) 301. On an upstream side of the first image forming apparatus 101, a feed deck 400 is connected, and on a downstream side of the second image forming apparatus 102, a stacker 600 is connected.

The feed deck 400 stores a larger number of recording materials than a recording material cassette 500 of the first image forming apparatus 101, and continuously feeds the recording materials. One pack of cut paper is constituted by 500 sheets of A3 paper having a basis weight of 80 g/m². The recording material cassette 500 stores one pack of cut paper including 500 sheets. On the other hand, the feed deck 400 stores 12 packs of cut paper including 6,000 sheets in total, and continuously feeds the sheets to the first image forming apparatus 101.

The stacker 600 stacks the recording materials output from the second image forming apparatus 102 on a delivery tray portion 610 or a stacker portion 620. The stacker portion 620 is arranged on a wagon so as to enable easily conveyance in subsequent processing steps. The stacker portion 620 stacks the output printed matters in the order of output from below. The delivery tray portion 610 is provided so as to output a printed matter at the time of test printing or interruption printing.

One stacker 600 has a stacking capacity of 6,000 sheets of A3 paper, which corresponds to the storing capacity of one feed deck 400. Therefore, when the same number of the stackers 600 as the feed decks 400 is additionally provided, it is possible to continuously operate the multiply-connecting image forming system 100 while securing a stacking space for the printed matters until all recording materials are used up.

The multiply-connecting image forming system 100 is operable in a first duplex image forming mode in which the first image forming apparatus 101 on the upstream side and the second image forming apparatus 102 on the downstream side perform printing on respective one sides of a recoding material in a divided manner for duplex printing of the recording material. In the first duplex image forming mode, a recording material is fed from the feed deck 400 (or the recording material cassette 500) one by one and is fed to a toner image forming portion 101A of the first image forming apparatus 101. In the toner image forming portion 101A, a toner image is formed, and the toner image is transferred onto a first surface of a recording material nipped and conveyed by a transferring portion T. The recording material having the toner image transferred thereon is heated and pressurized by a fixing device 202A to fix the image onto the first surface of the recording material. Then, the recording material is passed from the first image forming apparatus 101 to the relay unit 301. The relay unit 301 reverses the front surface and the back surface of the recording material received from the first image forming apparatus 101, and sends the recording material to the second image forming apparatus 102 in a state in which a second surface of the recording material is faced up.

In a toner image forming portion 101B of the second image forming apparatus 102, a toner image is formed, and the toner image is transferred onto the second surface of the recording material nipped and conveyed by a transferring portion T. The recording material having the toner image transferred thereon is heated and pressurized by a fixing device 202B to fix the image onto the second surface of the recording material. Then, the recording material is stacked in the stacker 600.

In recent years, image forming apparatus such as a copying machine, a printer, and a multifunction peripheral are demanded to have higher speed, higher image quality, and improved energy conservation. Therefore, the multiply-connecting image forming system 100 includes the relay unit for conveying the recording material between the first image forming apparatus 101 and the second image forming apparatus 102, thereby executing duplex printing in which the first image forming apparatus 101 and the second image forming apparatus 102 perform printing on respective one sides of a recording material in a divided manner.

The multiply-connecting image forming system 100 includes multiple sets of devices for charging, exposure, development, transfer, and fixing. Therefore, an image is formed on the first surface of the recording material at the first image forming apparatus 101, and after that, the recording material is reversed, and another image is formed on the second surface of the recording material at the second image forming apparatus 102.

Accordingly, the number of output pages in duplex printing is doubled as compared to the number of output pages in duplex printing performed by a single apparatus in the conventional case. Thus, printing can be performed at higher speed.

In the multiply-connecting image forming system 100, the first image forming apparatus 101 and the second image forming apparatus 102, which solely function as an image forming apparatus, are connected to each other through the relay unit 301. Accordingly, without a large-scale design change, the multiply-connecting image forming system 100 can be easily commercialized.

(Image Forming Apparatus)

The first image forming apparatus 101 and the second image forming apparatus 102 incorporated in the multiply-connecting image forming system 100 are monochrome printers having the same specification, which solely function as an image forming apparatus. Hereinafter, the first image forming apparatus 101 will be described, and redundant description for the second image forming apparatus 102 is omitted.

The toner image forming portion 101A includes, around a photosensitive drum 1, a charging roller 2, an exposure device 3, a development device 4, a transfer roller 5, and a drum cleaning device 6. The photosensitive drum 1 includes a photosensitive layer formed on an outer peripheral surface of an aluminum cylinder, and rotates in the direction indicated by the arrow of FIG. 1. The charging roller 2 is applied with a DC voltage on which an AC voltage is superimposed, thereby charging the surface of the photosensitive drum 1 to a uniform potential.

The exposure device 3 scans a laser beam by a rotary mirror, thereby reducing a surface potential of the charged photosensitive layer of the photosensitive drum 1 to form an electrostatic image on the photosensitive drum 1. When a copying function is executed, a document is read by an image reading device (scanner), and a laser beam output in accordance with the document image is applied to the photosensitive drum 1. When a printing function or a fax function is executed, image information from an external personal computer or telephone line is received by a controller 901 serving as an image receiving device, and a laser beam output in accordance with the received image is applied to the photosensitive drum 1.

The development device 4 causes a development sleeve to carry charged magnetic toner (one-component developer), and thus the electrostatic image on the photosensitive drum 1 is developed to form a toner image on the surface of the photosensitive drum 1. The transfer roller 5 is applied with a DC voltage having an opposite polarity to the charging polarity of the toner, and thus the toner image born on the photosensitive drum 1 is transferred onto a recording material P which is nipped and conveyed by the transferring portion T. The drum cleaning device 6 collects un-transferred residual toner which has not been transferred onto the recording material and remains on the photosensitive drum 1.

When the first image forming apparatus 101 performs simplex printing, the recording material which is fed from the feed deck 400 (or the recording material cassette 500) and has the first surface subjected to image formation is delivered outside from the first image forming apparatus 101 as it is. Meanwhile, when the first image forming apparatus 101 performs duplex printing alone, the recording material having the first surface subjected to image formation is conveyed to a reversal mechanism 11 to be switchback-conveyed, and is sent to a duplex conveyance path 12. The recording material having the first surface subjected to image formation is fed to the transferring portion T again in a state in which the front and back surfaces thereof are reversed, thereby transferring the toner image similarly onto the second surface. After that, the recording material is heated and pressurized by the fixing device 202A to fix the image similarly onto the second surface. The recording material having both surfaces subjected to image formation is delivered outside from the first image forming apparatus 101.

(Fixing Device)

The fixing device 202A of the first image forming apparatus 101 and the fixing device 202B of the second image forming apparatus 102 have the same configuration. Hereinafter, the fixing device 202A will be described, and redundant description for the fixing device 202B is omitted.

The fixing device 202A includes a fixing roller 211 and a pressure roller 212, which abut against each other to form a heating nip for the recording material. The fixing roller 211 is driven so as to rotate in the direction indicated by the arrow of FIG. 1 by a drive source (not shown), and the pressure roller 212 is rotated in association with the fixing roller 211.

In the fixing roller 211, a cylindrical core bar made of aluminum is covered with an elastic layer made of silicone rubber, and the elastic layer is covered with a release layer formed of a tube made of a fluorine resin (perfluoroalkoxy resin: PFA). A halogen heater 213 is arranged inside the fixing roller 211, and power to be input to the halogen heater 213 is automatically adjusted so that the surface temperature of the fixing roller 211, which is to be detected by a thermistor 215, becomes a predetermined target temperature.

The pressure roller 212 has both end portions pressurized by a pressure mechanism (not shown) toward the fixing roller 211 with a predetermined total pressure. In the pressure roller 212, a cylindrical core bar made of stainless steel is covered with an elastic layer made of silicone rubber, and the elastic layer is covered with a release layer formed of a tube made of a fluorine resin. A halogen heater 214 is arranged inside the pressure roller 212, and power to be input to the halogen heater 214 is automatically adjusted so that the surface temperature of the pressure roller 212, which is to be detected by a thermistor 216, becomes a predetermined target temperature.

(Relay Unit)

The relay unit 301 switchback-conveys the recording material received from the first image forming apparatus 101, and changes the trailing edge of the first surface to the leading edge of the second surface, thereby sending the recording material to the second image forming apparatus 102 in a state in which the front and back surfaces of the recording material are reversed.

In order to secure a time period to enable switchback conveyance of the recording material by the relay unit 301, it is necessary to reduce the productivity in the first image forming apparatus 101, and increase the feed interval (inter-sheet gap) between the recording materials as compared to a normal case. In order to avoid those situations, in a case where the process speed of the first image forming apparatus 101 is 500 mm/sec, the conveyance speed of the relay unit 301 is increased to 1,500 mm/sec. Accordingly, it becomes unnecessary to increase the feed interval (inter-sheet gap) between the recording materials in the first image forming apparatus 101, and the productivity of the image forming system 100 is prevented from being reduced. At the entrance of the relay unit 301, the conveyance speed of the recording material is increased from 500 mm/sec to 1,500 mm/sec and then switchback is performed. Then, at the exit of the relay unit 301, the conveyance speed of the recording material is decreased from 1,500 mm/sec to 500 mm/sec.

Note that, as illustrated in FIG. 2, a relay unit 302 may be used, which employs a reversal method other than the switchback conveyance method. The relay unit 302 rotates the recording material conveyed from the first image forming apparatus 101 in a spiral direction G while maintaining the traveling direction of the recording material, and reverses the front and back surfaces of the recording material so that the leading edge of the first surface directly becomes the leading edge of the second surface. In this state, the recording material is sent to the second image forming apparatus 102. The relay unit 302 aligns, with good accuracy, the image print-out positions at the leading edge portions of the first surface and the second surface of the recording material, and hence when the good image position accuracy is required, the relay unit 302 is more preferred than the relay unit 301 of FIG. 1.

Further, in a case that the first image forming apparatus 101 includes a face-down (switchback) output mechanism on the downstream of the fixing device 202A, after the front and back surfaces of the recording material are reversed by the face-down output mechanism, the recording material may be sent to a relay unit without the switchback function.

(Control System for Multiply-connecting Image Forming System)

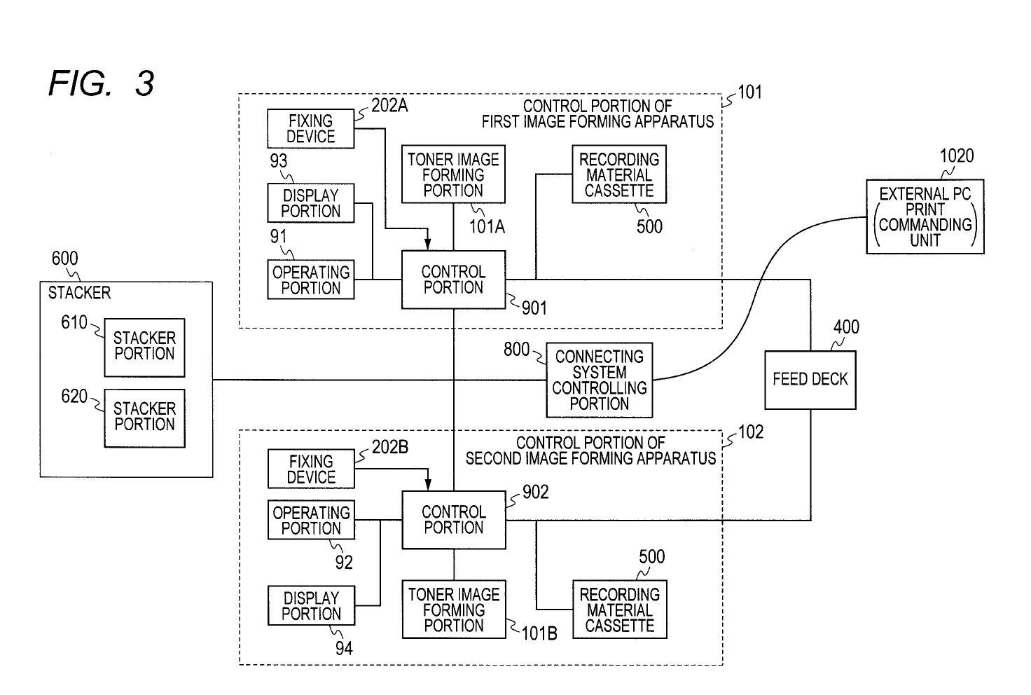

FIG. 3 is a block diagram illustrating a control system of the multiply-connecting image forming system. Referring to FIG. 1, as illustrated in FIG. 3, a connecting system controlling portion 800 performs system administration for the first image forming apparatus 101 and the second image forming apparatus 102. The connecting system controlling portion 800 is connected to a control portion 901 of the first image forming apparatus 101 and a control portion 902 of the second image forming apparatus 102 in a communicable state.

The control portion 901 controls, in response to a command from the connecting system controlling portion 800, the first image forming apparatus 101 so as to execute an image formation job, timely execute an operation of feeding the recording material from the recording material cassette 500, and execute power control in a waiting state. The control portion 902 controls, in response to a command from the connecting system controlling portion 800, the second image forming apparatus 102 so as to execute an image formation job, timely execute an operation of feeding the recording material from the recording material cassette 500, and execute power control in a waiting state.

The connecting system controlling portion 800 is connected to the feed deck 400 and the stacker 600 in a communicable state. The feed deck 400 sends, in response to a command from the connecting system controlling portion 800, a recording material to the first image forming apparatus 101. The stacker 600 stacks, in response to a command from the connecting system controlling portion 800, the recording material delivered from the second image forming apparatus 102.

(Network Communication System)

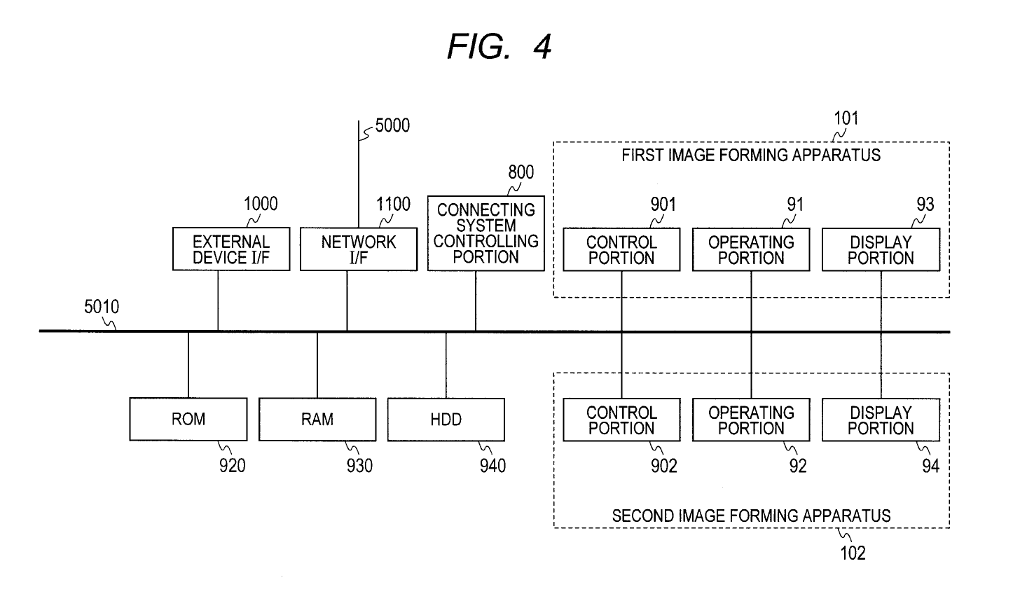

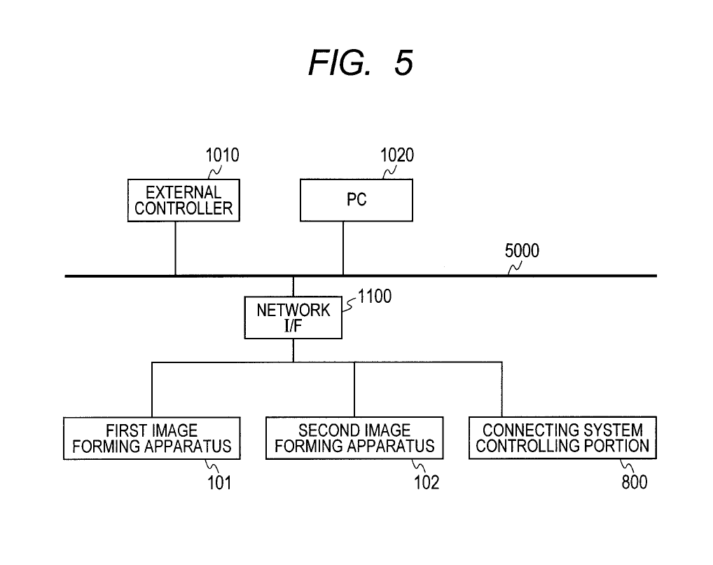

FIG. 4 is a block diagram illustrating a communication system of the multiply-connecting image forming system. FIG. 5 is an explanatory diagram illustrating access to the connecting system controlling portion from an external computer.

As illustrated in FIG. 4, the connecting system controlling portion 800 is connected to the first image forming apparatus 101, the second image forming apparatus 102, and the like via an apparatus communication cable 5010, which enables the connecting system controlling portion 800 to transmit and receive various kinds of data and command.

As illustrated in FIG. 5, the connecting system controlling portion 800 is connected to an Internet communication line (LAN) 5000 via a network interface (I/F) 1100, and performs data communication with an external computer 1020, an external controller 1010, and the like. The external computer 1020 is an input terminal through which a user performs transmission of an image formation job. The external controller 1010 is a terminal for performing inspection or remote control of the multiply-connecting image forming system 100 in service or the like.

The administrator of the multiply-connecting image forming system 100 accesses from the external computer 1020 to the external controller 1010, thereby enabling control and instruction to the connecting system controlling portion 800 via the external controller 1010.

(Waiting Mode)

In the multiply-connecting image forming system 100, through communication with an operating portion 91 of the first image forming apparatus 101, an operating portion 92 of the second image forming apparatus 102, the external computer 1020, a waiting state of the connecting system controlling portion 800 is settable.

The waiting mode refers to a mode in which the fixing device is controlled to a temperature lower than a temperature for fixing and is caused to wait for the image formation job until the temperature rises up to the fixing temperature. The waiting mode includes a power saving mode and a silent mode.

TABLE 1

| | Activation | | Waiting in | |
|---|---|---|---|---|
| | warm-up | Standby | power saving | Waiting in |
| | state | state | mode | silent mode |
| Control | ON | ON | ON | ON |
| portion | | | | |
| Toner image | ON | ON | ON | ON |
| forming | | | | |
| portion | | | | |
| Fan | ON | ON | ON | OFF |
| Conveying | ON | ON | ON | ON |
| portion | | | | |
| Fixing | ON | ON | Low | Low |
| device | | | temperature | temperature |
| | | | control | control |
| Power | 2,000 | 400 | 100 | 100 |
| consumption | | | | |
| (W) | | | | |

As shown in Table 1, in the standby state, a reception of the image formation job is waited for in a state in which the fixing devices 202A and 202B are each maintained at the temperature for fixing. Therefore, the image formation job can be immediately started at the same time as the reception of the image formation job.

When the status is put into the waiting state after the power saving mode is set, the power consumption in the waiting state can be reduced.

When the status is put into the waiting state after the silent mode is set, in addition to the reduction of the temperature of the fixing device, a scanner and a cooling fan are stopped. Therefore, this waiting mode can reduce a larger amount of power consumption.

When the power saving mode (or the silent mode) is set and when the standby state, in which the fixing devices 202A and 202B are maintained at the temperature for fixing, continues for a predetermined period of setting time, the temperature of the fixing devices 202A and 202B to be set is reduced to put the status into the waiting state.

(Setting through Operating Portion)

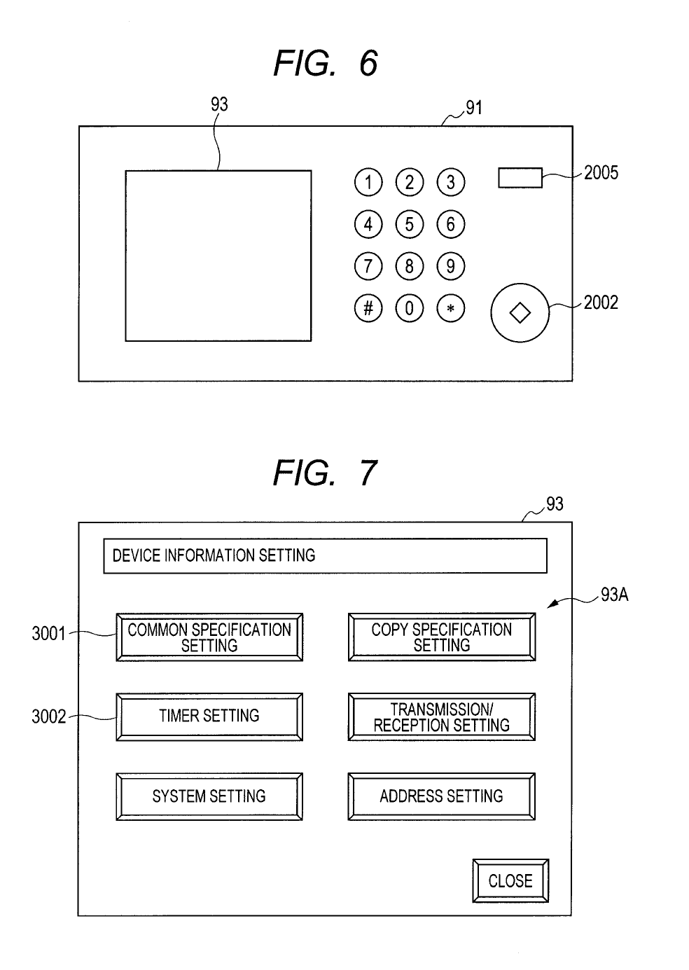

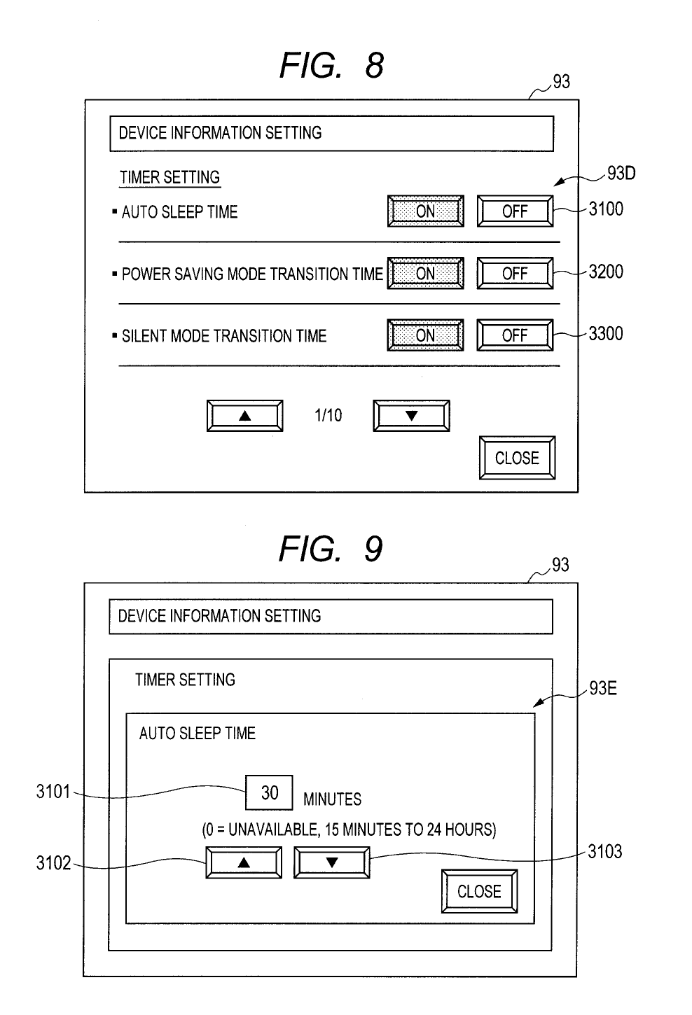

FIG. 6 is an explanatory diagram illustrating a configuration of the operating portion. The operating portion 91 includes an operation screen 93, an initial setting/registration button 2005, a print keypad 2002, and numerical keypads. FIG. 7 is an explanatory diagram illustrating an information setting screen. FIG. 8 is an explanatory diagram illustrating a timer setting screen. FIG. 9 is an explanatory diagram illustrating a sleep time setting screen. As illustrated in FIG. 8, when the operator presses an “ON/OFF button 3100” of “auto sleep time” on a timer setting screen 93D, an auto sleep time setting screen 93E illustrated in FIG. 9 is displayed. As illustrated in FIG. 9, when the operator presses “time setting keypads 3102 and 3103” on the auto sleep time setting screen 93E to adjust numerical values 3101 to an arbitrary time, and then presses a “close” button, registration of the setting time of the auto sleep mode is completed.

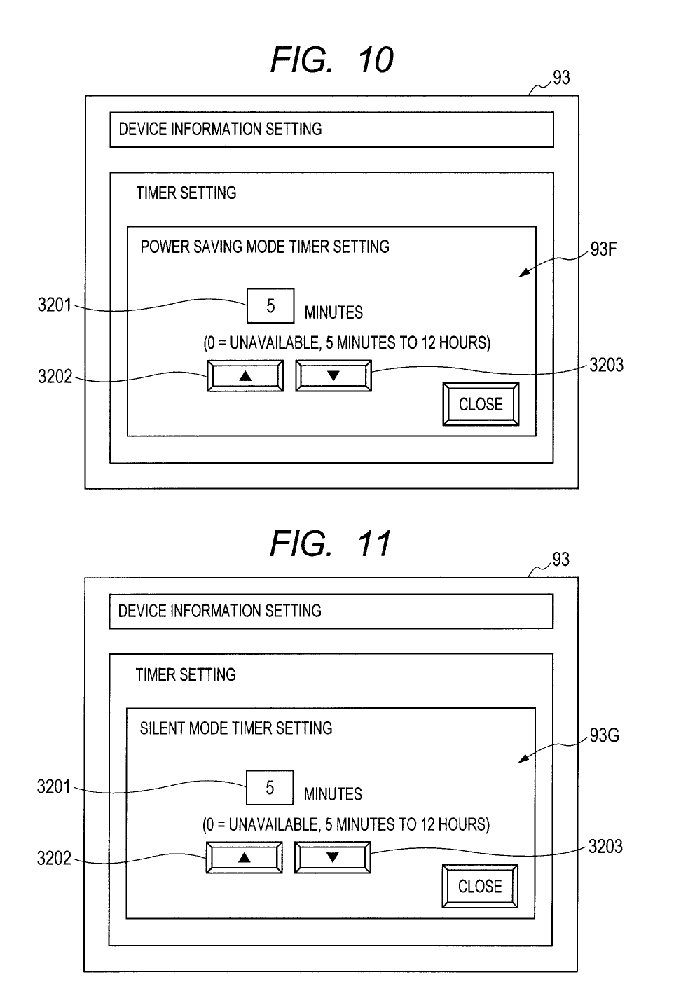

FIG. 10 is an explanatory diagram illustrating a power saving mode waiting state transition time setting screen. FIG. 11 is an explanatory diagram illustrating a silent mode waiting state transition time setting screen.

In a case that the multiply-connecting image forming system 100 is installed as a copy model, the operator can perform setting of a transition time to the waiting state of the power saving mode or to the waiting state of the silent mode through the operating portion (input portion) 91 of the first image forming apparatus 101 or the operating portion (input portion) 92 of the second image forming apparatus 102.

(1) As illustrated in FIG. 6, when the operator presses the “initial setting/registration button 2005” on the operating portion 91, an information setting screen 93A illustrated in FIG. 7 is displayed on the operation screen 93.

(2) As illustrated in FIG. 7, when the operator presses a “timer setting button 3002” on the information setting screen 93A, the timer setting screen 93D illustrated in FIG. 8 is displayed.

The following are settings on a transition time to the waiting state of the power saving mode.

(1) As illustrated in FIG. 8, when the operator presses an “ON/OFF button 3200” of “power saving mode waiting state transition time” on the timer setting screen 93D, a power saving mode waiting state transition time setting screen 93F illustrated in FIG. 10 is displayed.

(2) As illustrated in FIG. 10, when the operator presses “time setting keypads 3202 and 3203” on the power saving mode waiting state transition time setting screen 93F to adjust numerical values 3201 to an arbitrary time, and then presses a “close” button, registration of the transition time to the waiting state of the power saving mode is completed.

The following are settings on a transition time to the waiting state of the silent mode.

(1) As illustrated in FIG. 8, when the operator presses an “ON/OFF button 3300” of “silent mode waiting state transition time” on the timer setting screen 93D, a silent mode waiting state transition time setting screen 93G illustrated in FIG. 11 is displayed.

(2) As illustrated in FIG. 11, when the operator presses “time setting keypads 3302 and 3303” on the silent mode waiting state transition time setting screen 93G to adjust numerical values 3301 to an arbitrary time, and then presses a “close” button, registration of the transition time to the waiting state of the silent mode is completed.

(Setting through Network)

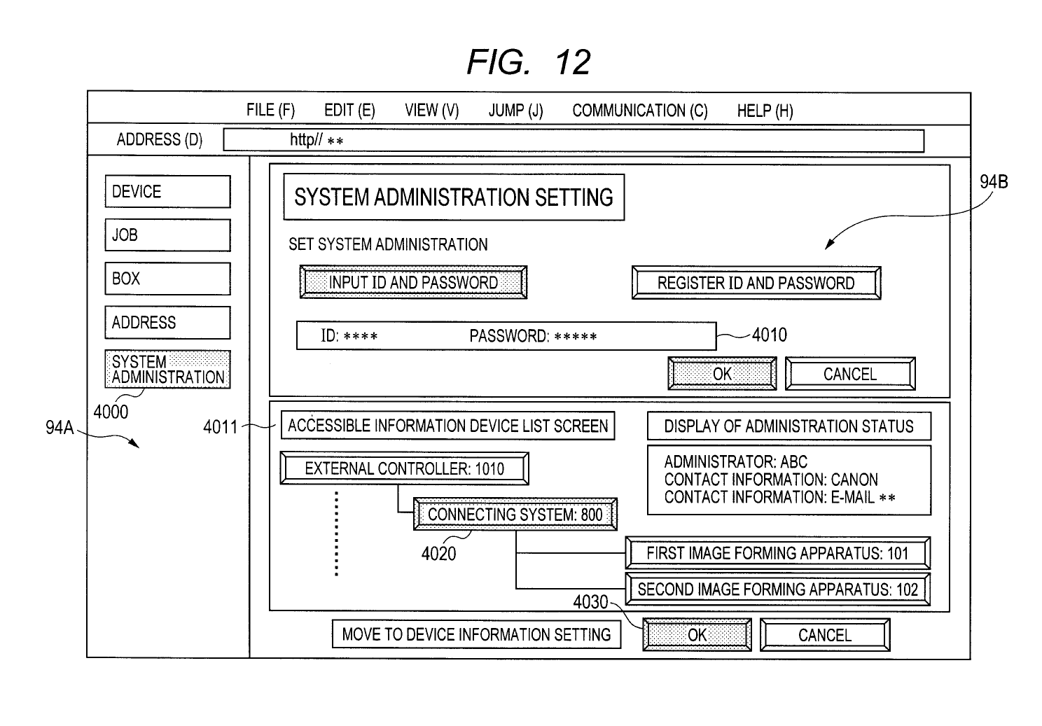

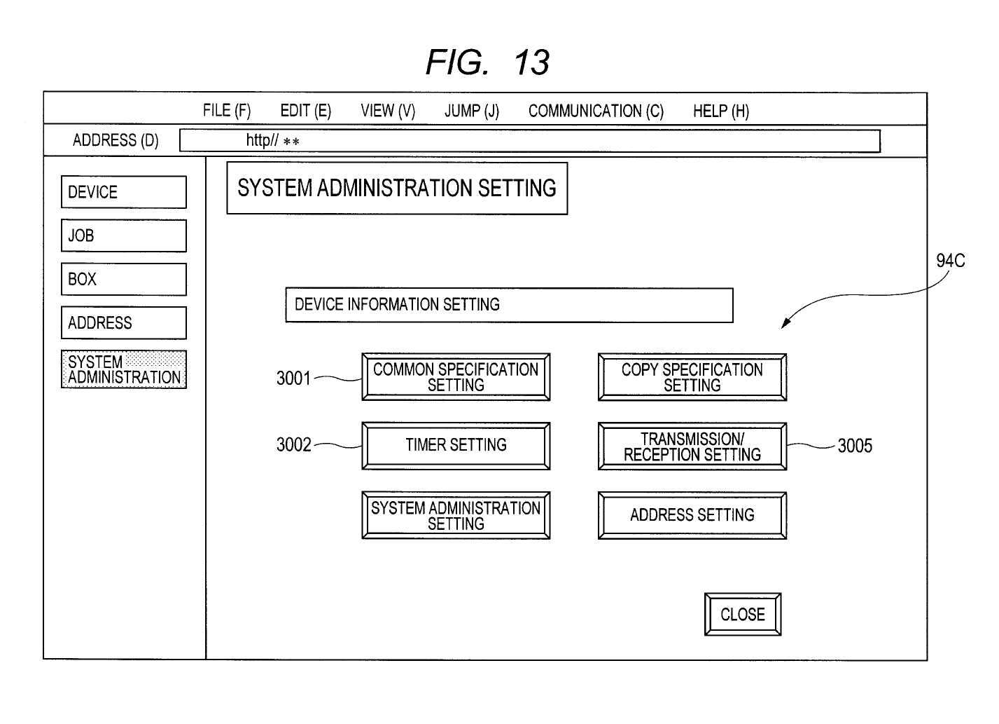

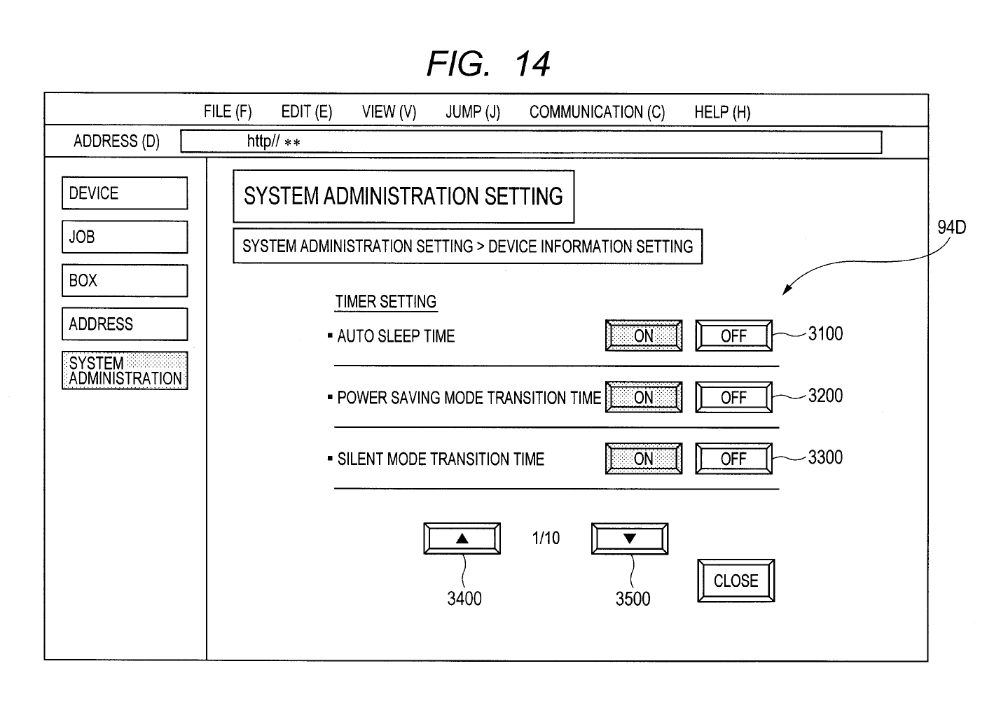

FIG. 12 is an explanatory diagram illustrating a menu screen. FIG. 13 is an explanatory diagram illustrating a system administration setting screen. FIG. 14 is an explanatory diagram illustrating a timer setting screen.

As illustrated in FIG. 5, when the multiply-connecting image forming system 100 is installed as a printer model, various settings of the multiply-connecting image forming system 100 are performed through network communication thereof. The user can perform setting of the multiply-connecting image forming system 100 regarding a transition time to the waiting state of the power saving mode or the silent mode through the external controller 1010 connected by network to the external computer 1020.

(1) The user accesses from the external computer 1020 to the external controller 1010 via the Internet communication line 5000.

(2) When the user accesses to an Internet address (URL) of the external controller 1010, a menu screen 94A illustrated in FIG. 12 is displayed.

(3) As illustrated in FIG. 12, when the user presses a “system administration button” 4000 on the menu screen 94A, a system administration setting screen 94B is displayed on the monitor screen.

(4) As illustrated in FIG. 12, the user inputs an “ID number” and a “password” in an input frame 4010 on the system administration setting screen 94B, and when the input data is authenticated, a user-accessible “information device list screen 4011” is display.

(5) As illustrated in FIG. 12, when the user selects a “connecting system controlling portion 800” button 4020 on the information device list screen 4011 and presses an “OK” button 4030, the external controller 1010 accesses to the connecting system controlling portion 800, with the result that the status enters a state in which various settings are settable.

(6) When the status enters a state in which an instruction is transmittable from the external controller 1010 to the connecting system controlling portion (input portion) 800, a system administration setting screen 94C illustrated in FIG. 13 is displayed on the monitor screen of the external computer 1020. The system administration setting screen 94C corresponds to the information setting screen 93A illustrated in FIG. 7. With the system administration setting screen 94C as an origin, various setting screens are displayed for system administration setting.

(7) As illustrated in FIG. 13, when the operator presses a “timer setting button 3002” on the system administration setting screen 94C, a timer setting screen 94D illustrated in FIG. 14 is displayed.

The following are settings on the transition time to the waiting state of the power saving mode.

(1) As illustrated in FIG. 14, when the operator presses an “ON/OFF button 3200” of “power saving mode waiting state transition time” on the timer setting screen 94D, a power saving mode waiting state transition time setting screen 93F illustrated in FIG. 10 is displayed.

(2) As illustrated in FIG. 10, when the operator presses the “time setting keypads 3202 and 3203” on the power saving mode waiting state transition time setting screen 93F to adjust the numerical values 3201 to an arbitrary time, and then presses the “close” button, registration of the transition time to the waiting state of the power saving mode is completed.

The following are settings on a transition time to the waiting state of the silent mode.

(1) As illustrated in FIG. 14, when the operator presses an “ON/OFF button 3300” of “silent mode waiting state transition time” on the timer setting screen 94D, the silent mode waiting state transition time setting screen 93G illustrated in FIG. 11 is displayed.

(2) As illustrated in FIG. 11, when the operator presses the “time setting keypads 3302 and 3303” on the silent mode waiting state transition time setting screen 93G to adjust the numerical values 3301 to an arbitrary time, and then presses the “close” button, registration of the transition time to the waiting state of the silent mode is completed.

Note that, the method of setting through external communication is not limited to this form. The necessary minimum components are, as illustrated in FIG. 5, the user's external computer 1020, external controller 1010, and network I/F 1100.

By the way, as illustrated in FIG. 1, in the multiply-connecting image forming system 100 which achieves higher speed in duplex printing, both the first image forming apparatus 101 and the second image forming apparatus 102 include the fixing devices 202A and 202B, respectively. Therefore, in order to maintain the standby state all the time during a period in which an image is not formed, excessive power consumption is necessary.

Therefore, in the multiply-connecting image forming system 100, in order to reduce the power consumption when waiting for the image formation job, the power saving mode and the silent mode are settable.

However, when the first image forming apparatus 101 and the second image forming apparatus 102 are always activated in a case where the multiply-connecting image forming system 100 receives an image formation job for duplex printing in the standby state, excessive power is consumed in some cases.

To address this problem, in the following embodiments, the activation control of the multiply-connecting image forming system 100 differs depending on whether or not the power saving mode or the silent mode is selected. When the image formation job for the duplex printing is received in the standby state, the activation of the system is appropriately set, thereby reducing the power consumption.

### First Embodiment

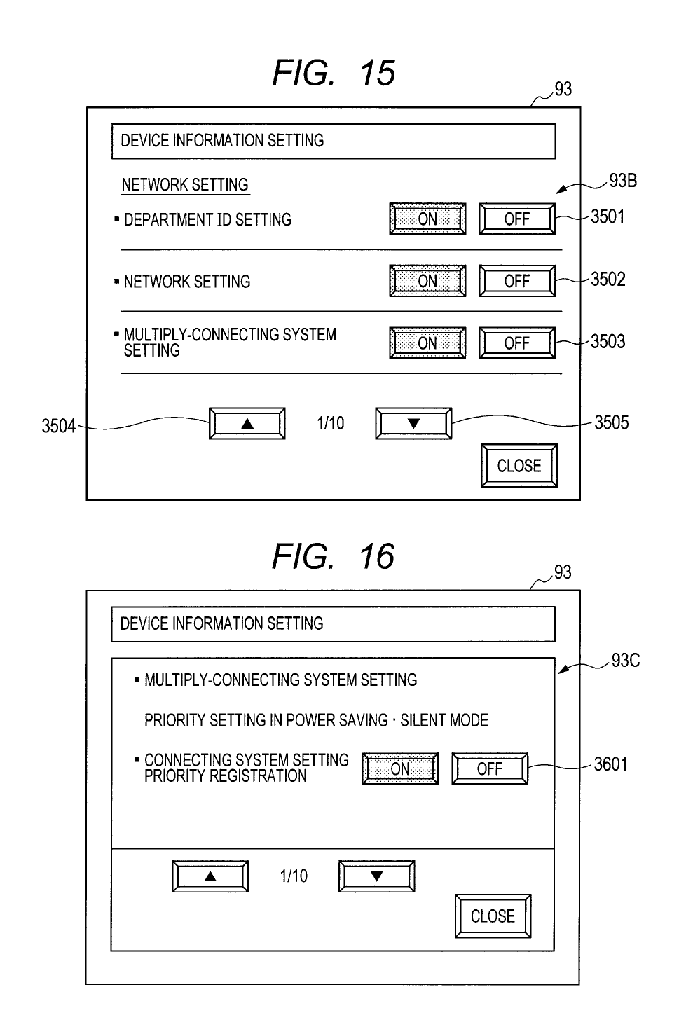

FIG. 15 is an explanatory diagram illustrating a network communication setting screen. FIG. 16 is an explanatory diagram illustrating a multiply-connecting system setting screen. In a case that the multiply-connecting image forming system 100 is installed as the copy model, the user can perform setting through the operating portion 91 of the first image forming apparatus 101 or the operating portion 92 of the second image forming apparatus 102 so that the second image forming apparatus is prioritized to be used at the time of recovery from the waiting mode.

As illustrated in FIG. 1, in the first image forming apparatus 101, the toner image forming portion 101A as an example of a first toner image forming portion forms a toner image on a recording material, and the fixing device 202A as an example of a first fixing portion fixes the toner image onto the recording material at a first heating temperature. In the second image forming apparatus 102, the toner image forming portion 101B as an example of a second toner image forming portion forms a toner image on a recording material, and the fixing device 202B as an example of a second fixing portion fixes the toner image onto the recording material at a second heating temperature. The feed deck 400 or the recording material cassette 500 as an example of a feed unit feeds the recording material to the toner image forming portions 101A and 101B. The relay unit 301 as an example of a conveyance path conveys, to the second image forming apparatus 102, the recording material output from the first image forming apparatus 101.

The multiply-connecting image forming system 100 is operable in the first duplex image forming mode, in which the recording material having an image formed thereon using the first image forming apparatus 101 is subjected to image formation again using the second image forming apparatus 102.

The connecting system controlling portion 800 selects the power saving mode or the silent mode.

In the standby state, the fixing device 202A and the fixing device 202B are each maintained at the fixing temperature to wait for the image formation job. In the waiting state of the power saving mode and in the waiting state of the silent mode, the first fixing portion and the second fixing portion each wait for input of the image formation job at a temperature lower than the fixing temperature.

When the image formation job for duplex printing is input at the time of transition to the waiting state of the waiting mode, the connecting system controlling portion 800 executes a second duplex image forming mode in priority to the first duplex image forming mode. In the second duplex image forming mode, in a state in which the fixing device 202A is maintained in the standby state, the toner image forming portion 101B and the fixing device 202B are used for starting the image formation on the recording material without using the toner image forming portion 101A.

Even in the case where the second duplex image forming mode is executed in the state in which the fixing device 202A is maintained in the standby state, the amount of power consumption is smaller than in the case where the first duplex image forming mode is executed. The following is the reason why the amount of power consumption is smaller. That is, when the number of duplex prints is the same, the period of time required to complete the image formation in the second duplex image forming mode is approximately twice as long as in the first duplex image forming mode, but the average power consumption of the fixing device as a whole is approximately half the average power consumption in the first duplex image forming mode. In this respect, there is no difference in power consumption between the first duplex image forming mode and the second duplex image forming mode. However, the first duplex image forming mode requires electric power for two sets of components other than the relay unit and the fixing device. In a comprehensive viewpoint, the amount of power consumption is smaller in the case where the second duplex image forming mode is executed.

The following are settings on registration for prioritizing the second duplex image forming mode.

(1) As illustrated in FIG. 6, when the operator presses the “initial setting/registration button 2005” on the operating portion 91, the information setting screen 93A illustrated in FIG. 7 is displayed on the operation screen 93.

(2) As illustrated in FIG. 7, when the operator presses a “common specification setting button 3001” on the information setting screen 93A, a network communication setting screen 93B illustrated in FIG. 15 is displayed. On the network communication setting screen 93B, a department ID setting button 3501, a network setting button 3502, and a multiply-connecting system setting button 3503 are displayed.

(3) As illustrated in FIG. 15, when the operator presses the “multiply-connecting system setting button 3503” on the network communication setting screen 93B, a multiply-connecting system setting screen 93C illustrated in FIG. 16 is displayed.

(4) As illustrated in FIG. 16, when the operator presses a priority registration setting button 3601 on the multiply-connecting system setting screen 93C, the “priority registration” (priority mode) is set “ON”.

Accordingly, the registration for prioritizing the second duplex image forming mode is set. After transition to the “power saving/silent mode,” the second duplex image forming mode is executed in priority to the first duplex image forming mode.

Further, the operator may execute similar settings using the external computer 1020 through the network.

As illustrated in FIG. 5, when the status enters a state in which an instruction is transmittable from the external controller 1010 to the connecting system controlling portion 800, the system administration setting screen 94C illustrated in FIG. 13 is displayed on the monitor screen of the external computer 1020.

(1) As illustrated in FIG. 13, when the operator presses the “common specification setting button 3001” on the system administration setting screen 94C, the network communication setting screen 93B illustrated in FIG. 15 is displayed.

(2) As illustrated in FIG. 15, when the operator presses the “multiply-connecting system setting button 3503” on the network communication setting screen 93B, the multiply-connecting system setting screen 93C illustrated in FIG. 16 is displayed.

(3) As illustrated in FIG. 16, on the multiply-connecting system setting screen 93C, the “priority registration” is set “ON”.

Accordingly, the registration for prioritizing the second duplex image forming mode is set. After transition to the waiting state of the “power saving/silent mode,” the second duplex image forming mode is executed in priority to the first duplex image forming mode.

The phrase “the second duplex image forming mode is executed in priority to the first duplex image forming mode” herein means that only the second image forming apparatus is used for the image formation even in a state in that the first image forming apparatus can be activated to execute printing. In other words, the phrase means that only the second image forming apparatus is used for the image formation even when the status does not fall in a state in which the first image forming apparatus is out of paper or our of toner so that the image formation is inexecutable.

In the first embodiment, an operation screen (GUI) of the external computer, through which a print job command is transmitted, is provided with the function of changing setting conditions of the multiply-connecting image forming system 100, with the result that the power consumption can be reduced as desired by the user.

### Second Embodiment

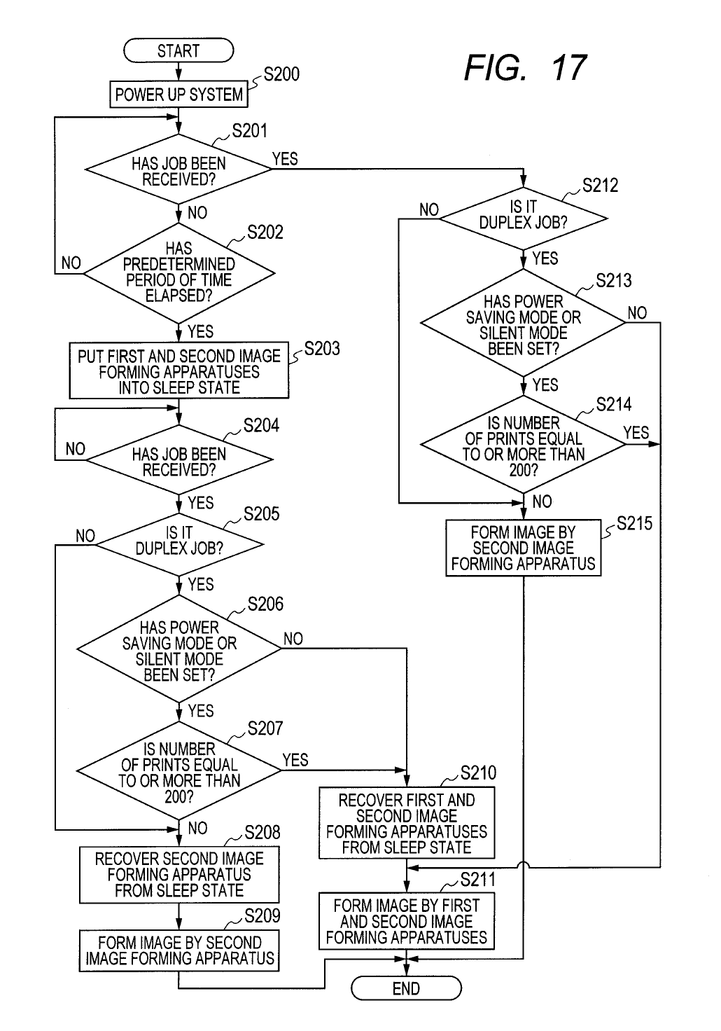

FIG. 17 is a flowchart illustrating duplex printing control according to a second embodiment of the present invention. As illustrated in FIG. 1, when the power saving mode is set, the connecting system controlling portion 800 puts the standby status into the waiting state of the power saving mode after continuing the standby state. When the image formation job is input, the connecting system controlling portion 800 executes the second duplex image forming mode. On the other hand, when the power saving mode or the silent mode is not set and when the image formation job is not input for a predetermined period of time in the standby state, the connecting system controlling portion 800 puts the standby status into a sleep state. The sleep state refers to a state in which the power supply to the fixing devices 202A and 202B is stopped and the power supply to the conveying portion and the fan is also stopped. When the image formation job is input in the sleep state, the connecting system controlling portion 800 executes the first duplex image forming mode.

When the number of prints of image formation in the image formation job input in the sleep state is less than a predetermined number, the connecting system controlling portion 800 executes the second duplex image forming mode. On the other hand, when the number of prints of image formation in the input image formation job is equal to or more than the predetermined number, the connecting system controlling portion 800 executes the first duplex image forming mode.

Referring to FIG. 1, when the multiply-connecting image forming system 100 is powered up as illustrated in FIG. 17, the connecting system controlling portion 800 executes activation and adjustment of the toner image forming portions 101A and 101B, and the fixing devices 202A and 202B (S200). When the image formation job is not received thereafter for a predetermined period of time (“Y” in S202), the connecting system controlling portion 800 commands the control portions 901 and 902 of the image forming apparatus 101 and 102 to put the status into the sleep state (S203). The control portions 901 and 902 having received the sleep state transition operation command put the status of the image forming apparatus 101 and 102 into the sleep state (S203).

In the second embodiment, an initial value of the transition time to the sleep state is set to 30 minutes. Therefore, when 30 minutes or more have elapsed without receiving the image formation job after the previous printing is completed, the connecting system controlling portion 800 puts the status into the sleep state.

In the sleep state, the power supply to the fixing devices is stopped, but the power supply to the connecting system controlling portion 800 and the control portions 901 and 902 is continued to wait for the image formation job (S201).

In the multiply-connecting image forming system, when the power saving mode or the silent mode is set and when the number of prints of image formation is less than the predetermined number, in response to reception of the image formation job in the sleep state, the fixing device 202B is activated and the stop of the power supply to the fixing device 202A is maintained. Also in the standby state in which the fixing devices 202A and 202B are activated, when the power saving mode or the silent mode is set and when the number of prints of image formation is less than the predetermined number, the second image forming apparatus 102 is used for executing the image formation job, and the power supply to the fixing device 202A is stopped. Accordingly, the amount of power consumption is further reduced as compared to the first embodiment.

When the connecting system controlling portion 800 receives the image formation job from the external computer 1020 (“Y” in S204), the connecting system controlling portion 800 terminates the sleep state and activates the multiply-connecting image forming system 100 (S208 or S210). At this time, the number of image forming apparatus to be activated differs depending on whether or not the power saving mode or the silent mode is set and whether the number of duplex prints in the image formation job is larger or smaller than the predetermined number.

When the image formation job is received in the sleep state (S203), the connecting system controlling portion 800 determines whether the image formation job is issued for the duplex printing or the simplex printing (S205). In the case of the simplex printing (“N” in S205), the first image forming apparatus 101 is not activated. Only the second image forming apparatus 102 is activated (S208), and the recording material fed from the recording material cassette 500 of the second image forming apparatus 102 is conveyed to the toner image forming portion 101B so that the simplex printing is executed (S209).

On the other hand, in the case of the duplex printing (“Y” in S205), the connecting system controlling portion 800 determines whether or not the power saving mode or the silent mode is set for the first image forming apparatus 101 and the second image forming apparatus 102 (S206).

Under the condition in which the power saving mode or the silent mode is selected (“Y” in S206), the connecting system controlling portion 800 determines whether or not the number of prints in the image formation job is equal to or more than 200 (S207). When the number of prints in the image formation job is less than 200 (“N” in S207), the connecting system controlling portion 800 transmits an activation command to the control portion 902 of the second image forming apparatus 102 to activate the second image forming apparatus 102 (S208). After that, the connecting system controlling portion 800 transmits a printing start command to execute the duplex printing operation by the second image forming apparatus 102 alone (S209). Note that, at this time, the connecting system controlling portion 800 commands the control portion 901 of the first image forming apparatus 101 to continue the sleep state.

On the other hand, when the power saving mode or the silent mode is not set (“N” in S206), the connecting system controlling portion 800 transmits the activation command to both the control portion 901 and the control portion 902 to activate both the first image forming apparatus 101 and the second image forming apparatus 102 (S210). After the fixing devices 202A and 202B are activated, the connecting system controlling portion 800 transmits the printing start command to execute the duplex printing operation in which the first image forming apparatus 101 and the second image forming apparatus 102 perform printing on respective one sides of a recording material in a divided manner (S211).

Also when the number of prints in the image formation job for the duplex printing is equal to or more than 200, the connecting system controlling portion 800 gives a higher priority to reduce the total processing time of the image formation job, and therefore activates both the first image forming apparatus 101 and the second image forming apparatus 102 (S210). Then, the connecting system controlling portion 800 executes the duplex printing operation in which the first image forming apparatus 101 and the second image forming apparatus 102 perform printing on respective one sides of a recording material in a divided manner (S211).

In the multiply-connecting image forming system 100 of the second embodiment, when the power saving mode or the silent mode is not selected and in the case of the duplex printing, both the first image forming apparatus 101 and the second image forming apparatus 102 are used for the duplex printing. When the power saving mode or the silent mode is set, in response to the reception of the image formation job after the transition to the sleep state, the second image forming apparatus 102 is used for the image formation in the state in which the first image forming apparatus is maintained in the sleep state.

In the second embodiment, when the image formation job is received in the sleep state of low power consumption, as long as the power saving mode or the silent mode is selected, only the second image forming apparatus 102 is activated to execute the image formation, irrespective of whether the simplex printing or the duplex printing is to be performed.

In the second embodiment, in the standby state or the sleep state, the image formation pattern or the activation pattern of the multiply-connecting image forming system 100 is changed depending on whether or not the “power saving/silent mode” is set. Accordingly, the power consumption is reduced.

### Third Embodiment

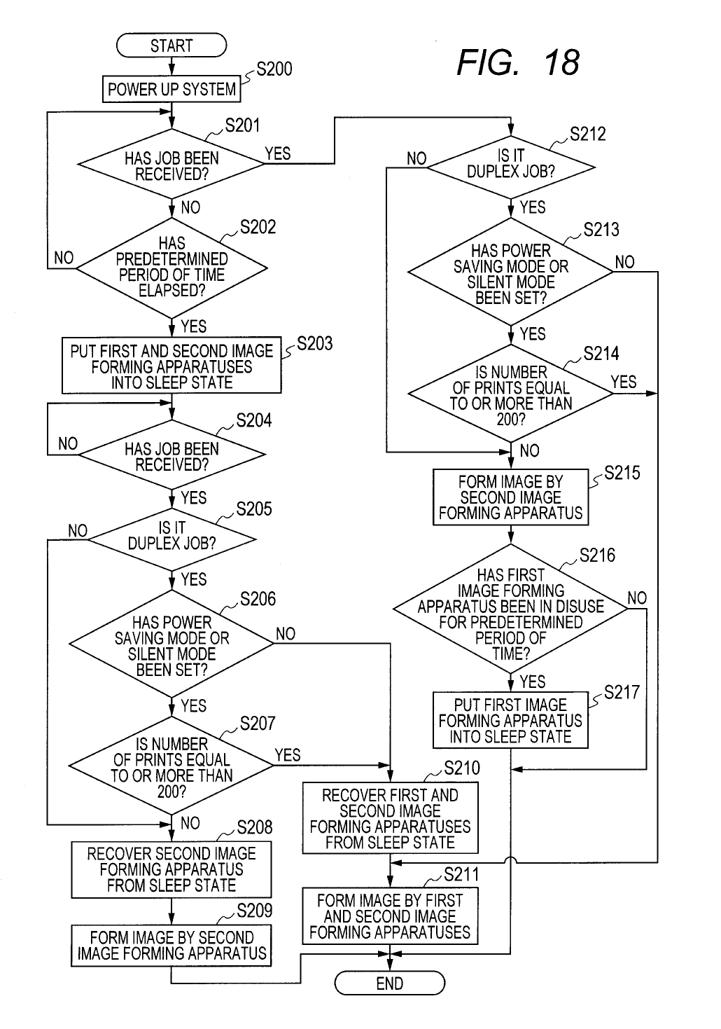

FIG. 18 is a flowchart illustrating duplex printing control according to a third embodiment of the present invention.

As illustrated in FIG. 17, in the second embodiment, when the power saving mode or the silent mode is selected, the second image forming apparatus 102 is used for executing the duplex printing, irrespective of whether the status in the reception of the image formation job falls under the standby state or the sleep state. However, from the viewpoint of reducing the power consumption, it is not preferred that the first image forming apparatus 101 that does not output images is caused to wait in the standby state during a period in which the second image forming apparatus 102 is executing the duplex printing.

Therefore, in the third embodiment, when the power saving mode or the silent mode is selected and when the image formation job for the duplex printing is input in the standby state, the power supply to the fixing device 202A is stopped after the second duplex image forming mode is started. The status of the first image forming apparatus 101 is put into the sleep state even during the period in which the second image forming apparatus 102 is executing the duplex printing, with the result that the power consumption is further reduced as compared to the first embodiment.

Referring to FIG. 17, as illustrated in FIG. 18, the processing in the sleep state, that is, the processing in Steps S200 to S215, is the same as that in the second embodiment, and redundant description is therefore omitted herein.

Until a predetermined period of time has elapsed after the multiply-connecting image forming system 100 is activated (“Y” in S202), the connecting system controlling portion 800 waits for the image formation job in the standby state, in which the fixing devices 202A and 202B are each maintained at the normal fixing temperature (S201).

When the image formation job is received, the connecting system controlling portion 800 determines whether the image formation job is issued for the duplex printing or the simplex printing (S212). In the case of the simplex printing (“N” in S212), the connecting system controlling portion 800 transmits an image formation command to the control portion 902, and the recording material fed from the recording material cassette 500 of the second image forming apparatus 102 is conveyed to the toner image forming portion 101B so that the simplex printing is executed (S215).

On the other hand, in the case of the duplex printing (“Y” in S212), the connecting system controlling portion 800 determines whether or not the power saving mode or the silent mode is set (S213). When the power saving mode or the silent mode is selected (“Y” in S213), the connecting system controlling portion 800 determines whether or not the number of prints is equal to or more than 200 (S214).

When the number of prints is less than 200 (“N” in S214), the connecting system controlling portion 800 transmits the printing start command to the control portion 902 of the second image forming apparatus 102 to execute the duplex printing by the second image forming apparatus 102 (S215).

On the other hand, when the power saving mode or the silent mode is not selected (“N” in S213), the connecting system controlling portion 800 transmits the printing start command to the control portion 901 and the control portion 902. Then, the connecting system controlling portion 800 executes the duplex printing in which the first image forming apparatus 101 and the second image forming apparatus 102 perform printing on respective one sides of a recording material in a divided manner (S211).

Also when the number of prints is equal to or more than 200, the connecting system controlling portion 800 gives priority to reducing the processing time of the image formation job, and therefore executes the duplex printing in which the first image forming apparatus 101 and the second image forming apparatus 102 perform printing on respective one sides of a recording material in a divided manner (S211).

When the simplex printing is selected (“N” in S212) or when the duplex printing is performed by the second image forming apparatus 102 (“Y” in S214), the connecting system controlling portion 800 determines whether or not a cumulative non-operational time of the first image forming apparatus 101 has reached a predetermined period of time (S216).

When the cumulative non-operational time of the first image forming apparatus 101 has reached the predetermined period of time (“Y” in S216), the connecting system controlling portion 800 issues, to the control portion 901, a command to put the status of the first image forming apparatus 101 into the sleep state (S217).

As described above, through the control of the third embodiment, the status of the first image forming apparatus 101 that is not in use during the period in which the second image forming apparatus 102 is in operation is put into the sleep state. When the second image forming apparatus 102 positioned downstream of the relay unit 301 in a conveyance direction starts the duplex printing for the recording material, the first image forming apparatus 101 positioned upstream of the relay unit 301 in the conveyance direction is put into the sleep state after the elapse of the predetermined period of time. Therefore, the electric power required for the first image forming apparatus 101 to maintain the standby state can be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-105840, filed May 11, 2011, which is hereby incorporated by reference herein in its entirety.

What is claimed is:

1. An image forming system, comprising:
a first image forming apparatus having: a first recording material containing portion configured to contain a recording material; and an image forming unit configured to form an image on the recording material;
a second image forming apparatus having: a second recording material containing portion configured to contain a recording material; and an image forming unit configured to form an image on the recording material;
a conveying unit configured to convey the recording material from the first image forming apparatus to the second image forming apparatus;
an executing unit configured to execute a duplex image forming mode including: a first duplex image forming mode in which a recording material, which is conveyed from the first recording material containing portion and has one surface subjected to image formation by the first image forming apparatus, is conveyed by the conveying unit, and another surface of the recording material is subjected to image formation by the second image forming apparatus; and a second duplex image forming mode in which one surface and another surface of a recording material conveyed from the second recording material containing portion are sequentially subjected to image formation by the second image forming apparatus; and
an input portion through which an operator inputs designation of executing the second duplex image forming mode.

2. An image forming system, comprising:
a first image forming apparatus having: a first recording material containing portion configured to contain a recording material; an image forming unit configured to form an image on the recording material; a first fixing unit configured to fix a toner image onto the recording material; and a first fixing temperature controlling portion configured to control a temperature of the first fixing unit at least to a temperature for fixing and to a waiting temperature that is lower than the temperature for fixing;
a second image forming apparatus having: a second recording material containing portion configured to contain a recording material; an image forming unit configured to form an image on the recording material; a second fixing unit configured to fix a toner image onto the recording material; and a second fixing temperature controlling portion configured to control a temperature of the second fixing unit at least to a temperature for fixing and to a waiting temperature that is lower than the temperature for fixing;
a conveying unit configured to convey the recording material from the first image forming apparatus to the second image forming apparatus;
an executing unit configured to execute a duplex image forming mode including: a first duplex image forming mode in which a recording material, which is conveyed from the first recording material containing portion and has one surface subjected to image formation by the first image forming apparatus, is conveyed by the conveying unit, and another surface of the recording material is subjected to image formation by the second image forming apparatus; and a second duplex image forming mode in which one surface and another surface of a recording material conveyed from the second recording material containing portion are sequentially subjected to image formation by the second image forming apparatus; and
an input portion through which an operator inputs designation of executing a waiting mode in which the first fixing temperature controlling portion controls the temperature of the first fixing unit at the waiting temperature that is lower than the temperature for fixing and the second fixing temperature controlling portion controls the temperature of the second fixing unit at the waiting temperature that is lower than the temperature for fixing,
wherein, when the operator designates the execution of the waiting mode through the input portion, and then the image forming system receives a duplex image forming command during the execution of the waiting mode, the executing unit executes the second duplex image forming mode in a state in which the first fixing temperature controlling portion controls the temperature of the first fixing unit at the waiting temperature.

3. An image forming system, comprising:
a first image forming apparatus having: a first recording material containing portion configured to contain a recording material; an image forming unit configured to form an image on the recording material; a first fixing unit configured to fix a toner image onto the recording material; and a first fixing temperature controlling portion configured to control a temperature of the first fixing unit at least to a temperature for fixing and to a waiting temperature that is lower than the temperature for fixing;
a second image forming apparatus having: a second recording material containing portion configured to contain a recording material; an image forming unit configured to form an image on the recording material; a second fixing unit configured to fix a toner image onto the recording material; and a second fixing temperature controlling portion configured to control a temperature of the second fixing unit at least to a temperature for fixing and to a waiting temperature that is lower than the temperature for fixing;
a conveying unit configured to convey the recording material from the first image forming apparatus to the second image forming apparatus;
an executing unit configured to execute a duplex image forming mode including: a first duplex image forming mode in which a recording material, which is conveyed from the first recording material containing portion and has one surface subjected to image formation by the first image forming apparatus, is conveyed by the conveying unit, and another surface of the recording material is subjected to image formation by the second image forming apparatus; and a second duplex image forming mode in which one surface and another surface of a recording material conveyed from the second recording material containing portion are sequentially subjected to image formation by the second image forming apparatus; and
an input portion through which an operator inputs designation of executing the second duplex image forming mode,
wherein, when the operator designates the execution of the second duplex image forming mode through the input portion, and then the image forming system receives a duplex image forming command in a period in which the first fixing temperature controlling portion controls the temperature of the first fixing unit at the waiting temperature that is lower than the temperature for fixing and the second fixing temperature controlling portion controls the temperature of the second fixing unit at the waiting temperature that is lower than the temperature for fixing, the executing unit executes the second duplex image forming mode in a state in which the first fixing temperature controlling portion controls the temperature of the first fixing unit at the waiting temperature.

4. An image forming system according to claim 2, wherein, when the operator inputs a setting of the waiting mode through the input portion, and then the image forming system receives the duplex image forming command, in a case where a designated number of recording materials to be subjected to duplex image formation is equal to or more than a predetermined value, the executing unit avoids executing the second duplex image forming mode and executes the first duplex image forming mode, and in a case where the designated number is less than the predetermined value, the executing unit avoids executing the first duplex image forming mode and executes the second duplex image forming mode.

5. An image forming system according to claim 3, wherein, when the operator inputs a setting of the second duplex image forming mode through the input portion, and then the image forming system receives the duplex image forming command, in a case where a designated number of recording materials to be subjected to duplex image formation is equal to or more than a predetermined value, the executing unit avoids executing the second duplex image forming mode and executes the first duplex image forming mode, and in a case where the designated number is less than the predetermined value, the executing unit avoids executing the first duplex image forming mode and executes the second duplex image forming mode.

6. An image forming system, comprising:
a first image forming apparatus having: a first recording material containing portion configured to contain a recording material; and an image forming unit configured to form an image on the recording material;
a second image forming apparatus having: a second recording material containing portion configured to contain a recording material; and an image forming unit configured to form an image on the recording material;
a conveying unit configured to convey the recording material from the first image forming apparatus to the second image forming apparatus;
an executing unit configured to execute a duplex image forming mode including: a first duplex image forming mode in which a recording material, which is conveyed from the first recording material containing portion and has one surface subjected to image formation by the first image forming apparatus, is conveyed by the conveying unit, and another surface of the recording material is subjected to image formation by the second image forming apparatus; and a second duplex image forming mode in which one surface and another surface of a recording material conveyed from the second recording material containing portion are sequentially subjected to image formation by the second image forming apparatus; and
an interface portion configured to receive an instruction of a setting of the second duplex image forming mode.

7. An image forming system, comprising:
a first image forming apparatus having: a first recording material containing portion configured to contain a recording material; an image forming unit configured to form an image on the recording material; a first fixing unit configured to fix a toner image onto the recording material; and a first fixing temperature controlling portion configured to control a temperature of the first fixing unit at least to a temperature for fixing and to a waiting temperature that is lower than the temperature for fixing;
a second image forming apparatus having: a second recording material containing portion configured to contain a recording material; an image forming unit configured to form an image on the recording material; a second fixing unit configured to fix a toner image onto the recording material; and a second fixing temperature controlling portion configured to control a temperature of the second fixing unit at least to a temperature for fixing and to a waiting temperature that is lower than the temperature for fixing;
a conveying unit configured to convey the recording material from the first image forming apparatus to the second image forming apparatus;
an executing unit configured to execute a duplex image forming mode including: a first duplex image forming mode in which a recording material, which is conveyed from the first recording material containing portion and has one surface subjected to image formation by the first image forming apparatus, is conveyed by the conveying unit, and another surface of the recording material is subjected to image formation by the second image forming apparatus; and a second duplex image forming mode in which one surface and another surface of a recording material conveyed from the second recording material containing portion are sequentially subjected to image formation by the second image forming apparatus; and
an interface portion configured to receive an instruction of a setting of a waiting mode in which the first fixing temperature controlling portion controls the temperature of the first fixing unit at the waiting temperature that is lower than the temperature for fixing and the second fixing temperature controlling portion controls the temperature of the second fixing unit at the waiting temperature that is lower than the temperature for fixing,
wherein, when the interface portion receives the instruction of the setting of the waiting mode, and then the image forming system receives a duplex image forming command during the execution of the waiting mode, the executing unit executes the second duplex image forming mode in a state in which the first fixing temperature controlling portion controls the temperature of the first fixing unit at the waiting temperature.

8. An image forming system, comprising:
a first image forming apparatus having: a first recording material containing portion configured to contain a recording material; an image forming unit configured to form an image on the recording material; a first fixing unit configured to fix a toner image onto the recording material; and a first fixing temperature controlling portion configured to control a temperature of the first fixing unit at least to a temperature for fixing and to a waiting temperature that is lower than the temperature for fixing;
a second image forming apparatus having: a second recording material containing portion configured to contain a recording material; an image forming unit configured to form an image on the recording material; a second fixing unit configured to fix a toner image onto the recording material; and a second fixing temperature controlling portion configured to control a temperature of the second fixing unit at least to a temperature for fixing and to a waiting temperature that is lower than the temperature for fixing;
a conveying unit configured to convey the recording material from the first image forming apparatus to the second image forming apparatus;
an executing unit configured to execute a duplex image forming mode including: a first duplex image forming mode in which a recording material, which is conveyed from the first recording material containing portion and has one surface subjected to image formation by the first image forming apparatus, is conveyed by the conveying unit, and another surface of the recording material is subjected to image formation by the second image forming apparatus; and a second duplex image forming mode in which one surface and another surface of a recording material conveyed from the second recording material containing portion are sequentially subjected to image formation by the second image forming apparatus; and
an interface portion configured to receive an instruction of a setting of the second duplex image forming mode,
wherein, when the interface portion receives the instruction of the setting of the second duplex image forming mode, and then the image forming system receives a duplex image forming command in a period in which the first fixing temperature controlling portion controls the temperature of the first fixing unit at the waiting temperature that is lower than the temperature for fixing and the second fixing temperature controlling portion controls the temperature of the second fixing unit at the waiting temperature that is lower than the temperature for fixing, the executing unit executes the second duplex image forming mode in a state in which the first fixing temperature controlling portion controls the temperature of the first fixing unit at the waiting temperature.

9. An image forming system according to claim 7, wherein, when the interface portion receives the instruction of the setting of the waiting mode, and then the image forming system receives the duplex image forming command, in a case where a designated number of recording materials to be subjected to duplex image formation is equal to or more than a predetermined value, the executing unit avoids executing the second duplex image forming mode and executes the first duplex image forming mode, and in a case where the designated number is less than the predetermined value, the executing unit avoids executing the first duplex image forming mode and executes the second duplex image forming mode.

10. An image forming system according to claim 8, wherein, when the interface portion receives the instruction of the setting of the second duplex image forming mode, and then the image forming system receives the duplex image forming command, in a case where a designated number of recording materials to be subjected to duplex image formation is equal to or more than a predetermined value, the executing unit avoids executing the second duplex image forming mode and executes the first duplex image forming mode, and in a case where the designated number is less than the predetermined value, the executing unit avoids executing the first duplex image forming mode and executes the second duplex image forming mode.
